(19) United States
(12) Patent Application Publication
(10) Pub. No.: US 2011/0260096 A1
(43) Pub. Date: Oct. 27, 2011

(54) HEAT DISSIPATOR COMPRISING FOAM OF RESIN COMPOSITION

(75) Inventor: Kenji ATARASHI, Kimitsu-shi (JP)

(73) Assignee: SUMITOMO CHEMICAL COMPANY, LIMITED, Tokyo (JP)

(21) Appl. No.: 13/004,932

(22) Filed: Jan. 12, 2011

(30) Foreign Application Priority Data
Apr. 23, 2010 (JP) 2010-099511

(51) Int. Cl. C09K 5/00

(52) U.S. Cl. 252/73

(57) ABSTRACT

A heat dissipator comprising foam of a resin composition, which contains a thermoplastic resin, carbon fiber and a modified polyolefin modified by an unsaturated carboxylic acid or its derivative, wherein the resin composition has a melt flow rate of 5 g/10 minutes or more, and the foam has a foaming ratio of 1.05 to less than 1.70, and has thermal conductivity in a horizontal direction of 1 W/mK or more, and in a vertical direction of 0.6 W/mK or more, measured by a laser flash method; and a part for a lighting equipment comprising the above heat dissipator.

### FIELD OF THE INVENTION

The present invention relates to a heat dissipator comprising foam of a resin composition.

### BACKGROUND OF THE INVENTION

In recent years, an LED illumination has been replacing an incandescent light and fluorescent light, from a viewpoint of energy saving. Insufficient heat dissipation from an LED devise results in performance degradation and life shortening of the LED devise. Therefore, there has been used a heat-sink made of an alloy having high thermal conductivity such as an aluminum alloy, in order to dissipate heat generated from an LED devise. However, the aluminum alloy is much poorer in its workability and heavier than a thermoplastic resin represented by a polyolefin, although the aluminum alloy is low in its specific gravity among metallic alloys. Accordingly, there has been desired a lightweight heat dissipator excellent in its workability.

JP 2008-69284A discloses a resin composition containing 100 parts by weight of a matrix resin, and 100 to 250 parts by weight of a particulate resin having high thermal conductivity, wherein the particulate resin has on its surface a filler layer having thermal conductivity of 10 W/mK or more.

JP 2007-238917A discloses a thermal conductive resin composition containing a thermoplastic resin, an impact modifier, and particulate graphite having an aspect ratio of 10 to 20, a weight-average particle diameter of 10 to 200 μm, and a fixed carbon content of 98% by weight or more.

### SUMMARY OF THE INVENTION

However, above resin composition disclosed in JP 2008-69284A is insufficient in its thermal conductivity, and JP 2008-69284A discloses nothing about an anisotropic nature of thermal conductivity, although it discloses a certain amount of consideration about workability of the resin composition. A large anisotropic nature of thermal conductivity makes it difficult to dissipate heat efficiently from a relatively intricately-shaped heat dissipator having a heat dissipating fin. Above resin composition disclosed in JP 2007-238917A is not investigated sufficiently about its workability, although JP 2007-238917A discloses an anisotropic nature of thermal conductivity.

In view of the above circumstances, the present invention has an object to provide a heat dissipator having good thermal conductivity and a small anisotropic nature of thermal conductivity.

The present invention is a heat dissipator comprising foam of a resin composition, containing:
45.0 to 89.5% by weight of a thermoplastic resin;
to 50% by weight of carbon fiber; and
0.5 to 5.0% by weight of a modified polyolefin modified by an unsaturated carboxylic acid or its derivative;
   wherein the resin composition has a melt flow rate of 5 g/10 minutes or more, measured at 230° C. under a load of 2.16 kg according to JIS K-7210, and the foam has a foaming ratio of 1.05 to less than 1.70, and has thermal conductivity in a horizontal direction of 1 W/mK or more, measured by a laser flash method, and thermal conductivity in a vertical direction of 0.6 W/mK or more, measured by a laser flash method, provided that the total weight of the thermoplastic resin, the carbon fiber, and the modified polyolefin is 100% by weight. “JIS” in above JIS-K-7210 is “Japan Industrial Standard”.

Also, the present invention is a part for a lighting equipment, comprising the above heat dissipator.

### BRIEF DESCRIPTION OF THE DRAWINGS

FIG. 1 shows (1) a test piece [right side: having a size of 1 mm (thickness: a direction indicated by the arrowed line)×12 mm (height)×10 mm (width)] used for measuring thermal conductivity in a horizontal direction, wherein the horizontal direction is indicated by the arrowed line, and (2) a laminate consisting of three plates (left side) used for preparing the above test piece by cutting work along the two dot-lines, wherein (2-1) those three plates adhere well to one another, (2-2) those three plates are prepared by an injection molding method, (2-3) those three plates are the same in their size, 80 mm (length=depth)×10 mm (width, corresponding to width of a gate in the injection molding)×4 mm (thickness), and (2-4) the above horizontal direction indicated by the arrowed line (FIG. 1, right) means a machine direction in the injection molding.

FIG. 2 shows (1) a test piece (right side) used for measuring thermal conductivity in a vertical direction, wherein the vertical direction is indicated by the arrowed line, and (2) the plate (left side: completely the same as the plate in FIG. 1) used for preparing the above test piece by cutting work. Therefore, the above vertical direction indicated by the arrowed line (FIG. 2, right) means a direction vertical to the above machine direction.

### DETAILED DESCRIPTION OF THE INVENTION

### Thermoplastic Resin

The thermoplastic resin in the present invention means a resin shapeable at 200 to 450° C. Examples thereof are a polyolefin resin, a polystyrene resin, a polyamide resin, a halogenated vinyl resin, a polyacetal resin, a polyester resin, a polycarbonate resin, a polyaryl sulfone resin, a polyaryl ketone resin, a polyphenylene ether resin, a polyphenylene sulfide resin, a polyarylether ketone resin, a polyether sulfone resin, a polyphenylene sulfide sulfone resin, a polyallylate resin, a liquid crystalline polyester resin, a fluorine resin, and a combination of two or more thereof. Among them, preferred is a polyolefin resin or a polystyrene resin, from a viewpoint of workability for a relatively intricately-shaped part such as an electric or electronic part.

Preferable examples of the above polyolefin resin are (1) a polypropylene resin containing a propylene unit as a major monomer unit, (2) a polyethylene resin containing an ethylene unit as a major monomer unit, (3) an α-olefin resin containing an α-olefin unit as a major monomer unit, the α-olefin having 4 or more carbon atoms, wherein the above “monomer unit” such as the “propylene unit” and the “ethylene unit” means a unit of a polymerized monomer.

Examples of the above polypropylene resin are a propylene homopolymer, a propylene-ethylene random copolymer, and a propylene-ethylene block copolymer produced by a production method comprising steps of (i) polymerizing propylene, thereby forming a propylene homopolymer, and (ii) copolymerizing propylene with ethylene in the presence of the propylene homopolymer, thereby forming a propylene-ethylene copolymer, the above block copolymer being substantially a mixture of the propylene homopolymer with the propylene-ethylene copolymer. Among them, preferred is the propylene-ethylene block copolymer.

Examples of the above ethylene resin are an ethylene homopolymer, and an ethylene-α-olefin random copolymer, the α-olefin having 4 or more carbon atoms.

An example of the above α-olefin resin is an α-olefin-propylene random copolymer.

Examples of the α-olefin having 4 or more carbon atoms are 1-butene, 2-methyl-1-propene, 2-methyl-1-butene, 3-methyl-1-butene, 1-hexene, 2-ethyl-1-butene, 2,3-dimethyl-1-butene, 1-pentene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecene. Among them, preferred is 1-butene, 1-pentene, 1-hexene, or 1-octene.

Examples of a polymerization method of an olefin are (1) a bulk polymerization method carried out in a medium of an olefin, which is liquid at polymerization temperature, (2) a solution or slurry polymerization method carried out in an inert hydrocarbon solvent such as propane, butane, isobutane, pentane, hexane, heptane and octane, and (3) a gas-phase polymerization method carried out in a medium of a gaseous olefin. Those polymerization methods are carried out in a batch-wise manner, or in a stepwise manner with the use of plural polymerization reactors connected with one another in series, or in a combined manner thereof. From an industrial and economical point of view, preferred is a continuous gas-phase polymerization method, or a bulk-gas-phase polymerization method carrying out continuously both a bulk polymerization method and a gas-phase polymerization method. Polymerization conditions, such as polymerization temperature, polymerization pressure, polymerization time, a monomer concentration, a catalyst amount used, are arbitrarily determined.

Examples of a catalyst used for the above olefin polymerization are a multisite catalyst formed by use of a solid catalyst component containing a titanium atom, a magnesium atom and a halogen atom, and a single site catalyst such as metallocene catalyst. The former multisite catalyst is preferable for producing the above polypropylene resin.

An isotactic pentad fraction of the above propylene homopolymer is preferably 0.95 or more, and further preferably 0.98 or more, measured by a ¹³C-NMR method. The isotactic pentad fraction means a fraction of a propylene unit existing in the center of an isotactic chain, on a pentad basis, contained in a molecular chain of the propylene homopolymer; in other words, an is tactic pentad fraction is a fraction of a propylene unit existing in a chain consisting of a sequential meso-bond of five propylene units, the “chain consisting of a sequential meso-bond of five propylene units” being referred to hereinafter as “mmmm”. The is tactic pentad fraction is measured by a ¹³C-NMR method disclosed in Macromolecules, 6, 925 (1973) authored by A. Zambelli et al., wherein the isotactic pentad fraction is a ratio of an mmmm peak area to an absorption peak area in a methyl carbon region.

The above thermoplastic resin has a melt flow rate (MFR) of preferably 30 to 200 g/10 minutes, and more preferably 50 to 100 g/10 minutes, measured at 230° C. under a load of 2.16 kg, according to JIS K-7210.

The thermoplastic resin is contained in the resin composition in an amount of 45.0 to 89.5% by weight, preferably 55.0 to 79.5% by weight, and more preferably 60.0 to 74.5% by weight. When its amount is smaller than 45.0% by weight, foam molding of the resin composition may be difficult, which results in a large anisotropic nature of thermal conductivity of the molded foam. When its amount is larger than 89.5% by weight, the molded foam may be insufficient in its thermal conductivity.

### Carbon Fiber

The carbon fiber in the present invention is preferably pitch carbon fiber having thermal conductivity of more than 200 W/mK. Examples thereof are DIALEAD (trade name) manufactured by Mitsubishi Plastics, Inc., and RAHEAMA (trade name) manufactured by Teijin Limited.

The carbon fiber may be treated with a binder on its surface. Examples of the binder are the above polyolefin resin, a polyurethane resin, a polyester resin, an acrylic resin, an epoxy resin, starch, and plant oil. Those binders may be combined with an acid-modified polyolefin, a surface preparation agent such as a silane coupling agent, or a lubricant such as paraffin wax.

Examples of a method for treating the carbon fiber with a binder are (1) a method comprising a step of immersing the carbon fiber in an aqueous solution of a binder, and (2) a method comprising a step of spraying an aqueous solution of a binder to the carbon fiber.

The carbon fiber contained in the resin composition has number average fiber length of preferably 0.5 mm or longer, and more preferably 0.7 mm or longer, and has a fiber diameter of preferably 5 μm or larger, which length results in a small anisotropic nature of thermal conductivity. The above number average fiber length (unit: mm) can be measured by a method comprising steps of (i) removing a resin from the resin composition with a Soxhlet extractor (solvent: xylene), thereby recovering the fiber, and (ii) measuring its number average fiber length by a method disclosed in JP 2002-5924A.

The carbon fiber is contained in the resin composition in an amount of 10 to 50% by weight, preferably 20 to 40% by weight, and more preferably 25 to 45% by weight. When its amount is smaller than 10% by weight, the obtained foam may be insufficient in its thermal conductivity. When its amount is larger than 50% by weight, the resin composition may be inferior in its foaming ability.

### Modified Polyolefin

Although the modified polyolefin in the present invention is a kind of thermoplastic resin, the modified polyolefin in the present invention is different from the above thermoplastic resin; namely, the above thermoplastic resin does not encompass the modified polyolefin in the present invention. Examples of the modified polyolefin in the present invention are the following (a), (b), (c) and (d), and a combination of two or more thereof:

(a) a modified polyolefin obtained by a method comprising a step of grafting one or more compounds selected from the group consisting of an unsaturated carboxylic acid and its derivative, onto an olefin homopolymer;

(b) a modified polyolefin obtained by a method comprising a step of grafting one or more compounds selected from the group consisting of an unsaturated carboxylic acid and its derivative, onto an olefin copolymer of two or more olefins;

(c) a modified polyolefin obtained by a method comprising a step of grafting one or more compounds selected from the group consisting of an unsaturated carboxylic acid and its derivative, onto an olefin block copolymer produced by a method comprising steps of (i) polymerizing an olefin, thereby forming an olefin homopolymer, and (ii) copolymerizing two or more olefins in the presence of the olefin homopolymer; and

(d) a modified polyolefin obtained by a method comprising a step of copolymerizing one or more olefins with one or more compounds selected from the group consisting of an unsaturated carboxylic acid and its derivative.

Examples of an olefin homopolymer or copolymer used for producing above modified polyolefin (a) or (b) are polypropylene, polyethylene, and a poly-α-olefin containing an α-olefin unit having four or more carbon atoms as a major monomer unit.

Examples of the above unsaturated carboxylic acid are maleic acid, fumaric acid, itaconic acid, acrylic acid, and methacrylic acid.

Examples of the above derivative of an unsaturated carboxylic acid are an acid anhydride of the above unsaturated carboxylic acid, an ester thereof, an amide thereof, an imide thereof, and a metal salt thereof. Specific examples thereof are maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, 2-hydroxyethyl methacrylate, monoethyl maleate, diethyl maleate, monomethyl fumarate, dimethyl fumarate, acrylamide, methacrylamide, a monoamide of maleic acid, a diamide of maleic acid, a monoamide of fumaric acid, maleimide, N-butylmaleimide, and sodium methacrylate. The unsaturated carboxylic acid or its derivative in the present invention means a compound such as citric acid and malic acid, which may be converted into an unsaturated carboxylic acid or its derivative by a reaction occurring in a modifying step, such as a dehydration reaction.

The unsaturated carboxylic acid or its derivative is preferably glycidyl acrylate, glycidyl methacrylate, maleic anhydride, or 2-hydroxyethyl methacrylate.

Examples of a method for producing the above modified polymer are a solution method, a bulk method, a melt-kneading method, and a combined method of two or more thereof, those methods being disclosed in a document such as “Practical Polymer Alloy Designing” authored by Humio I D E, published by Kogyo Chosakai Publishing Co., Ltd. (1996); Prog. Polym. Sci., 24, 81-142 (1999); JP 2002-308947A; JP 2004-292581A; JP 2004-217753A; and JP 2004-217754A.

The above modified polyolefin may be a commercially-available modified polyolefin, such as MODIPER (trade name) manufactured by NOF Corporation; BLEMMER CP (trade name) manufactured by NOF Corporation; BONDFAST (trade name) manufactured by Sumitomo Chemical Co., Ltd.; BONDINE (trade name) manufactured by Sumitomo Chemical Co., Ltd.; REXPEARL (trade name) manufactured by Japan Polyethylene Corporation; ADMER (trade name) manufactured by Mitsui Chemicals, Inc.; MODIC AP (trade name) manufactured by Mitsubishi Chemical Corporation; POLYBOND (trade name) manufactured by Chemtura Corporation; and YUMEX (trade name) manufactured by Sanyo Chemical Industries, Ltd.

The modified polyolefin is contained in the resin composition in an amount of 0.5 to 5.0% by weight, preferably 0.5 to 3.0% by weight, and more preferably 0.5 to 2.0% by weight. When its amount is smaller than 0.5% by weight, (i) the heat dissipator may be inferior in its bonding capability to a metal part, or (ii) the heat dissipator may make insufficient adherence to an LED devise, thereby forming a gap. Such an insufficient adherence results in an inflow of air to the LED through the gap, and so the air prevents thermal conduction from the LED to the heat dissipator, which results in insufficient heat dissipation. When its amount is larger than 5.0% by weight, the obtained foam may be insufficient in its thermal conductivity.

### Organic Fiber

Examples of the organic fiber in the present invention are synthetic fiber such as polyester fiber, polyamide fiber, polyurethane fiber, a polyimide fiber, polyolefin fiber and polyacrylonitrile fiber; and plant fiber such as kenaf fiber. Among them, preferred is polyester fiber.

The organic fiber is used preferably in a combination thereof with a polymer such as the above thermoplastic resin, the above modified polyolefin, polyester elastomer, and styrene-butadiene elastomer; namely, is used preferably as an organic fiber-resin containing composition. An example of a method for producing the organic fiber-containing resin composition is that disclosed in JP 2006-8995A. The organic fiber-containing resin composition contains the organic fiber in an amount of usually 10 to 60% by weight, provided that the total weight of the organic fiber and the polymer is 100% by weight. When producing the organic fiber-containing resin composition by the use of the thermoplastic resin or modified polyolefin in the present invention, its amount used is counted in the above-defined amount of the thermoplastic resin or modified polyolefin in the present invention, 45.0 to 89.5% by weight or 0.5 to 5.0% by weight.

The resin composition in the present invention contains the organic fiber as an optional component in an amount of usually 3 to 10 parts by weight, and preferably 3 to 5 parts by weight, provided that the total weight of the thermoplastic resin (for example, a polyolefin resin), the carbon fiber and the modified polyolefin is 100 parts by weight.

### Filler and Additive

The resin composition in the present invention may contain any filler, such as glass fiber, talc, wollastonite, and glass flake. The resin composition may also contain any additive such as a neutralizing agent, a plasticizer, a lubricant, a mold release agent, an anti-adhesive agent, an antioxidant, a thermal stabilizer, a light stabilizer, a flame-retardant, a pigment, and a dye, in order to improve processing, mechanical, electric, thermal or surface characteristics, or light stability of the resin composition.

### Resin Composition

The resin composition in the present invention is not limited in its production method. An example thereof is a method comprising steps of (i) mixing homogeneously the above thermoplastic resin, carbon fiber and modified polyolefin, and the above optionally-used or organic fiber, filler or additive with one another by used of a Henschel mixer or a tumbler, and (ii) melt-kneading the resultant mixture with a plasticizing apparatus. The plasticizing apparatus is preferably regulated in its temperature and stirring condition to inhibit cutoff of the carbon fiber during the melt-kneading, thereby repressing formation of short carbon fiber.

The above thermoplastic resin, carbon fiber and modified polyolefin, and optionally-used organic fiber, filler or additive, and further optionally-used rubber such as polyolefin elastomer, polyester elastomer, polyurethane elastomer, and polyvinyl chloride elastomer are supplied to a plasticizing apparatus through one inlet of the plasticizing apparatus, or through plural inlets thereof separately from one another. The plasticizing apparatus heats the thermoplastic resin up to temperature higher than its melting temperature, and kneads the resultant molten thermoplastic resin. Examples of the plasticizing apparatus are a Banbury mixer, a single screw extruder, a co-rotating twin screw extruder (for example, TEM (trade name) manufactured by Toshiba Machine Co., Ltd. and TEX (trade name) manufactured by The Japan Steel Works, Ltd.), and a counter-rotating twin screw extruder (for example, FCM (trade name) manufactured by Kobe Steel, Ltd. and CMP (trade name) manufactured by The Japan Steel Works, Ltd.

### Foam

The foam in the present invention can be produced by a method comprising steps of (i) adding a foaming agent to the above resin composition, and (ii) foam molding. Examples of the foaming agent are a chemical foaming agent and a physical foaming agent. The foaming agent is used in an amount of preferably 0.1 to 10 parts by weight, and more preferably 0.2 to 8 parts by weight, per 100 parts by weight of the resin composition. The foam molding disarranges an orientation of the carbon fiber, which results in a foam having a small anisotropic nature of thermal conductivity, and in particular, a foam having improved thermal conductivity in its vertical direction.

The above foaming agent is an inorganic or organic compound, and is used singly, or in combination of two or more of those compounds. An example of the inorganic foaming agent is a hydrogen carbonate such as sodium hydrogen carbonate. Examples of the organic foaming agent are a polycarboxylic acid such as citric acid, and an azo compound such as azodicarbonamide (ADCA).

Examples of the above physical foaming agent are an inert gas such as nitrogen and carbon dioxide, and a volatile organic compound. Among them, preferred is carbon dioxide in a supercritical state, nitrogen, or a combination thereof. Similarly to the above chemical foaming agent, the physical foaming agent is used singly, or in combination of two or more thereof. The physical foaming agent may be used in combination with the chemical foaming agent. The physical foaming agent is preferably mixed with the molten resin composition in its supercritical state. Since the physical foaming agent in a supercritical state has high solubility for a resin, it can diffuse homogeneously in the molten resin composition in a short time, which results in a foam having a high foaming ratio, and a homogeneous foaming cell structure. An example of a method for mixing a physical foaming agent with the molten resin composition is a method comprising a step of inletting the physical foaming agent into a nozzle or a cylinder of an injection molding apparatus.

Examples of a foam molding method of a resin composition are an injection foam molding method, a press foam molding method, an extrusion foam molding method, and a stampable foam molding method. Among them, preferred is an injection foam molding method, or a press foam molding method.

The foam in the present invention has a foaming ratio of 1.05 to less than 1.70, and preferably 1.05 to less than 1.50. When the foaming ratio is 1.70 or more, an absolute amount of the carbon fiber contained in a unit volume of the foam is too small, which results in a heat dissipator having insufficient thermal conductivity.

The foaming ratio can be obtained by dividing a density of the resin composition by a density of the foam, the density being measure according to ASTM D792.

In order to improve thermal conductivity in the vertical direction of the foam, at least one surface of the foam is preferably a flat and smooth skin layer formed at the time of foam molding, for the following reason. When bonding a metal thin film (for example, aluminum thin film) to a foam having no flat and smooth skin layer, such a foam may make insufficient adherence to the metal thin film, thereby forming a gap. Such an insufficient adherence results in an inflow of air between the metal thin film and the foam through the gap, and so the air prevents thermal conduction in the vertical direction.

The foam in the present invention may have an epidermis material affixed to its partial surface, in order to further improve thermal conductivity in a horizontal direction of the foam. The epidermis material may be a material known in the art, and an example thereof is a thin film of a metal having high thermal conductivity such as aluminum.

Since the heat dissipator of the present invention is light-weight, and has good thermal conductivity and a small anisotropic nature of thermal conductivity, it can be preferably used for a heat-generating electric or electronic part, such as a part for a lightning equipment (for example, LED illumination), even if the electric or electronic part has a relatively intricate shape.

### EXAMPLE

The present invention is explained in more detail with reference to the following Examples, which do not limit the present invention.

Components (starting materials) used were as follows:

### 1. Thermoplastic Resin

NOBLENE AU161C (trade name of Sumitomo Chemical Co., Ltd.):

A propylene-ethylene block copolymer produced by the above-mentioned method, an isotactic pentad fraction of its propylene homopolymer part being 0.98, and a proportion of its propylene-ethylene copolymer part being 12% by weight, and its MFR being 90 g/10 minutes.

The above proportion “12% by weight” was obtained from the following formula:

X=1−(ΔHf)T/(ΔHf)P

wherein X is a proportion of a propylene-ethylene copolymer part; (ΔHf)T is a melting heat of a propylene-ethylene block copolymer measured by differential scanning calorimetry (DSC); and (ΔHf)P is a melting heat of a propylene homopolymer part measured thereby.

### 2. Carbon Fiber

DIALEAD K223HE (trade name of Mitsubishi Plastics, Inc.):

Its fiber length, fiber diameter and thermal conductivity shown in its catalog are 6 mm, 11 μm and 550 W/mK, respectively.

### 3. Modified Polyolefin

Maleic anhydride-modified polypropylene:

This modified polyolefin was produced by a method disclosed in Example 1 of JP 2004-197068A, and was found to have an MFR of 70 g/10 minutes, and a graft amount of maleic anhydride of 0.6% by weight, the total of the modified polyolefin being 100% by weight, measured based on an absorption peak of maleic anhydride in an IR spectrum of the modified polyolefin.

### 4. Organic Finer-Containing Resin Composition

An organic fiber-containing resin composition was produced by a method comprising steps of:

(1) impregnating polyethylene 2,6-naphthalate fiber having a diameter of 35 μm with a molten resin at about 200° C. according to a method disclosed in JP 3-121146A, wherein (1-1) the polyethylene 2,6-naphthalate fiber was manufactured by Teijin Fibers Limited by melt-spinning chips of polyethylene 2,6-naphthalate having intrinsic viscosity of 0.62 dL/g, the polyethylene naphthalate fiber having on its surface 2.0% by weight of a polyurethane resin, (1-2) the polyethylene 2,6-naphthalate fiber was drawn continuously through a crosshead die connected to an extruder, (1-3) the molten resin was supplied continuously from the extruder, (1-4) the molten resin was a mixture of 95 parts by weight of a propylene homopolymer, NOBLENE U501E-1, having a melt flow rate of 120 g/10 minutes, manufacture by Sumitomo Chemical Co., Ltd. with 5 parts by weight of a maleic anhydride-modified polyolefin having a melt flow rate of 70 g/10 minutes and containing 0.6% by weight of maleic anhydride grafted, prepared according to Example 1 of JP2004-197068A;

(2) passing the impregnated fiber through a cross-head die to form a strand;

(3) pulling the strand at a pulling rate of 13 meter/minute; and

(4) cutting the strand, thereby obtaining an organic finer-containing resin composition in a shape of a pellet having length of 11 mm, wherein the organic finer-containing resin composition contained 30.0% by weight of the organic fiber, 66.5% by weight of the thermoplastic resin and 3.5% by weight of the modified polyolefin, the total weight of those three components being 100% by weight.

### 5. Filler

Carbon Black ENSACO 350G (trade name of TIMCAL Graphite & Carbon.

### 6. Additive

5-1: Sumilizer GA80 (trade name of Sumitomo Chemical Co., Ltd.) having a chemical name of 3,9-bis[2-(3-(3-tert-butyl-4-hydroxy-5-methylphenyl) propionyloxy)-1,1-dimethylethyl]-2,4,8,10-tetraoxaspiro[5.5]undecane (antioxidant).
5-2: Ultranox 626 (trade name mark of GE Specialty Chemicals Inc.) having a chemical name of bis(2,4-di-tert-butylphenyl) pentaerythritoldiphosphite (antioxidant).

### Examples 1 to 4 and Comparative Examples 1 to 3

The above starting materials were used to produce resin compositions 1 to 5 as shown in Table 1. Those resin compositions were produced by a method, comprising steps of (i) weighing out the starting materials in their amounts as shown in Table 1, provided that the total amount of the thermoplastic resin, carbon fiber and modified polyolefin was 100% by weight and also 100 parts by weight, (ii) putting them in a plastic bag, and waggling it strongly, thereby mixing them homogeneously, (iii) melt-kneading the resultant mixture with a 20 mm-single screw extruder, VS 20-26, manufactured by TANABE PLASTICS MACHINERY CO., LTD. at cylinder temperature of 180° C., and (iv) cutting the resultant melt-kneaded resin composition into a 3 mm-long pellet.

The above pellet was mixed with a chemical foaming agent, Celmike C-1, manufactured by Sankyo Kasei Co., Ltd., in their amounts as shown in Table 2, and the resultant mixture was injection-molded at cylinder temperature of 220° C. with an injection molding machine, TOYO SI-30III, manufactured by Toyo Seiki Seisaku-sho, LTD., at mold temperature of 50° C. and an injection speed of 20 mm/sec, while keeping the pressure of 25 MPa, thereby making a foamed test piece having a size of 80 mm×10 mm×4 mm (thickness).

Comparative Example 1 using no foaming agent was carried out similarly to the above, thereby making a non-foamed dense test piece having a size of 80 mm×10 mm×4 mm (thickness).

Regarding an amount of a material supplied to a cylinder of an injection molding machine, a “metering value” in Comparative Example 1 (foaming ratio=1.00) was 53 mm; that in Examples 1 to 4 were 44 mm; that in Comparative Example 2 was 35 mm; and that in Comparative Example 3 was 46 mm. The term “metering value” is generally used in a technical field of injection molding, and corresponds to a position of a cylinder of an injection molding machine, and therefore corresponds to an amount of a material supplied to a cylinder thereof. The larger the metering value is, the larger the amount of a material supplied is.

TABLE 1

| | Resin composition | | | | |
|---|---|---|---|---|---|
| | 1 | 2 | 3 | 4 | 5 |
| Thermoplastic | 74.0 | 74.0 | 49.0 | 49.0 | 49.0 |
| resin (% by | | | | | |
| weight) | | | | | |
| Carbon fiber | 25.0 | 25.0 | 50.0 | 50.0 | 50.0 |
| (% by weight) | | | | | |
| Modified | 1.0 | 1.0 | 1.0 | 1.0 | 1.0 |
| polyolefin | | | | | |
| (% by weight) | | | | | |
| Additive | | | | | |
| (part by weight) | | | | | |
| Sumilizer GA80 | 0.05 | 0.05 | 0.05 | 0.05 | 0.05 |
| Ultranox 626 | 0.10 | 0.10 | 0.10 | 0.10 | 0.10 |
| Organic fiber- | | | | | |
| containing resin | | | | | |
| composition | | | | | |
| Amount as the | 0.0 | 20.0 | 0.0 | 10.0 | 20.0 |
| composition | | | | | |
| (part by weight) | | | | | |
| Amount as the | 0.0 | 6.0 | 0.0 | 3.0 | 6.0 |
| organic fiber | | | | | |
| (part by weight) | | | | | |
| Melt flow rate | | 20 | 17 | 15 | 13 |
| (g/10 minutes) | | | | | |

TABLE 2

| | Example | | | | Comparative Example | | |
|---|---|---|---|---|---|---|---|
| | 1 | 2 | 3 | 4 | 1 | 2 | 3 |
| Material used (part by weight) | | | | | | | |
| Resin composition (pellet) | | | | | | | |
| Resin composition 1 | | | | | | 100 | |
| Resin composition 2 | | | 100 | | | | |
| Resin composition 3 | 100 | | | | 100 | | |
| Resin composition 4 | | | | 100 | | | |
| Resin composition 5 | | 100 | | | | | 100 |
| Foaming agent | 1 | 1 | 1 | 1 | 0 | 1 | 1 |
| Evaluation of test piece | | | | | | | |
| Number-average fiber length of | 0.5 | 0.5 | 0.5 | 0.5 | | | |
| carbon fiber (mm) | | | | | | | |
| Specific gravity | 1.19 | 1.13 | 0.95 | 1.16 | 1.27 | 0.62 | 1.15 |
| Foaming ratio | 1.06 | 1.07 | 1.10 | 1.06 | 1.00 | 1.75 | 1.04 |
| Thermal conductivity (W/m · K) | | | | | | | |
| Horizontal direction | 11.6 | 7.7 | 3.6 | 8.2 | | | 8.2 |
| Vertical direction | 3.3 | 2.3 | 1.7 | 3.2 | 1.5 | 0.4 | 1.5 |
| Flexural modulus (MPa) | 5,550 | 4,740 | 3,410 | 5,130 | 6,420 | | 5,350 |
| Izod impact strength (kJ/m²) | 2.7 | 6.1 | 5.5 | 4.4 | 2.9 | | 8.4 |

The above melt flow rate was measured at 230° C. under a load of 2.16 kg according to JIS K7210.

The above number-average fiber length of the carbon fiber contained in the test piece was measured according to a method comprising steps of:

(i) removing the resin from the test piece with a Soxhlet extractor (solvent: xylene), thereby recovering the carbon fiber; and

(ii) measuring its number average fiber length by a method disclosed in JP 2002-5924A.

The above foaming ratio was measured by dividing specific gravity of the resin composition by specific gravity of the test piece, the specific gravity being measured according to ASTM D792.

The above thermal conductivity was measured by a laser flash method with a thermal constant measuring apparatus, TC-7000, manufactured by ULVAC RICO Inc., as follows:

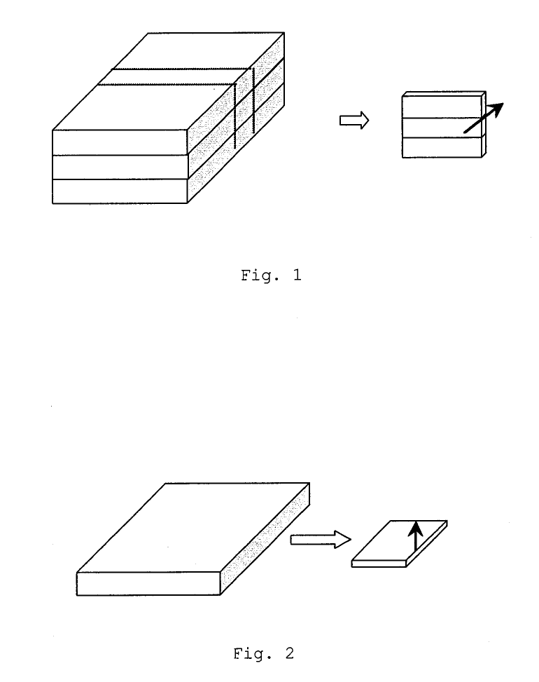

(1) the thermal conductivity in a horizontal direction was measured using the test piece as shown in FIG. 1 (right side), whose arrowed line indicates the horizontal direction; and

(2) the thermal conductivity in a vertical direction was measured using the test piece as shown in FIG. 2 (right side), whose arrowed line indicates the vertical direction.

The above flexural modulus was measured according to JIS K7171, under the following conditions:
measurement temperature of 23° C.;
span length of 64 mm;
width of 10 mm; and
loading speed of 2.0 mm/minute.

The above Izod impact strength (notched) was measured at 23° C. according to JIS K7110.

Table 2 shows the following:
Examples 1 to 4 provided a test piece (heat dissipator) having small specific gravity, high thermal conductivity both in a horizontal direction and in a vertical direction;
Comparative Example 2 provided a test piece (foamed material) having too large foaming ratio and small thermal conductivity in a vertical direction;
Comparing Example 1 with Comparative Example 1 (wherein the both used the same resin composition 3 as each other, and were different from each other in their foaming ratio), Example 1 provided a test piece (heat dissipator) having higher thermal conductivity in a vertical direction than that in Comparative Example 1;
Comparing Example 2 with Comparative Example 3 (wherein the both used the same resin composition 5 as each other, and were different from each other in their foaming ratio), Example 2 provided a test piece (heat dissipator) having higher thermal conductivity in a vertical direction than that in Comparative Example 3;
the organic fiber contained in resin compositions 2, 4 and 5 contributed to improvement of Izod impact strength; and
Example 2 provided a test piece (heat dissipator) having smaller anisotropic nature of thermal conductivity than that in Comparative Example 3, wherein the anisotropic nature thereof is defined as a value obtained by dividing the thermal conductivity in a horizontal direction by the thermal conductivity in a vertical direction, as shown in the following table.

| | Example 2 | Comp. Example 3 |
|---|---|---|
| Anisotropic nature | 3.3 | 5.5 |
| Foaming ratio | 1.07 | 1.04 |

| | |
|---|---|
| Resin composition used | Resin composition 5 |

### Example 5 and Comparative Examples 4 to 7

The above starting materials were used to produce resin compositions 6 to 8 as shown in Table 3. Those resin compositions were produced by a method, comprising steps of (i) weighing out the starting materials in their amounts as shown in Table 3, provided that the total amount of the thermoplastic resin, carbon fiber, modified polyolefin and filler was 100% by weight and also 100 parts by weight, (ii) putting them in a plastic bag, and waggling it strongly, thereby mixing them homogeneously, (iii) melt-kneading the resultant mixture at 180° C. with a test roll machine, type HR-20F, manufactured by Nisshin Kagaku K.K., and (iv) cutting the resultant melt-kneaded resin composition into a flake 10 mm square.

The above flake was mixed with a chemical foaming agent, Celmike C-1, in their amounts as shown in Table 4, and the resultant mixture was press molded with a press molding machine, F-37, manufactured by Shinto Kinzoku Kogyosho, at 230° C., thereby making a foamed test piece having a size of 80 mm×10 mm×5 mm (thickness). Comparative Examples 4 to 6 were similarly carried out using no foaming agent, thereby making a non-foamed dense test piece having a size of 80 mm×10 mm×5 mm (thickness).

TABLE 3

| | Resin composition | | |
|---|---|---|---|
| | 6 | 7 | 8 |
| Thermoplastic resin (% by weight) | 76.0 | 80.0 | 100 |
| Carbon fiber (% by weight) | 15.0 | 20.0 | — |
| Modified polyolefin (% by weight) | 4.0 | — | — |
| Filler (% by weight) | 5.0 | — | — |
| Additive (part by weight) | | | |
| Sumilizer GA80 | 0.05 | 0.05 | 0.05 |
| Ultranox 626 | 0.10 | 0.10 | 0.10 |
| Melt flow rate (g/10 minutes) | 5 | 38 | 90 |

TABLE 4

| | Example | Comparative Example | | | |
|---|---|---|---|---|---|
| | 5 | 4 | 5 | 6 | 7 |
| Material used | | | | | |
| (part by weight) | | | | | |
| Resin composition (flake) | | | | | |
| Resin composition 6 | 100 | 100 | | | |
| Resin composition 7 | | | 100 | | |
| Resin composition 8 | | | | 100 | 100 |
| Foaming agent | 1 | 0 | 0 | 0 | 1 |
| Evaluation of test piece | | | | | |
| Number-average fiber | 0.9 | | | | |
| length of carbon fiber | | | | | |
| (mm) | | | | | |
| Specific gravity | 0.78 | 1.01 | 1.01 | 0.90 | 0.60 |
| Foaming ratio | 1.3 | 1.0 | 1.0 | 1.0 | 1.5 |
| Order of temperature | 1 | 2 | | 3 | 4 |
| elevation | | | | | |
| Bonding capability | good | good | bad | bad | bad |
| to metal | | | | | |

The above melt flow rate, number-average fiber length of the carbon fiber, specific gravity and foaming ratio were measured by the same methods as those mentioned above.

The above order of temperature elevation was measured to investigate dependency of thermal conduction of the test piece on its composition and foaming condition. The temperature elevation of the surface of the test piece was observed using a thermal image photographing apparatus, THERMOTRACER TH 5104, manufactured by NEC Avio Infrared Technologies Co., Ltd., by the following method comprising steps of:

(i) cutting off a test specimen (20 mm×20 mm×5 mm (thickness)) from the above test piece having a size of 80 mm×80 mm×5 mm (thickness);

(ii) putting the test specimen on a glass petri dish;

(iii) allowing the test specimen-carrying glass petri dish to stand in a temperature-controlled room at 23° C. for one hour;

(iv) putting the test specimen-carrying glass petri dish on a hot plate maintained at 75° C.; and

(v) photographing its thermal image every five seconds.

Table 4 shows the order (1, 2, 3 and 4) of the temperature elevation, in the order of fastest elevation (order 1) to slowest elevation (order 4).

The above bonding capability to metal was evaluated by the following method, comprising steps of:

(i) carrying out press molding similarly to the above with the press-molding machine, F-37, provided that an aluminum foil was placed in advance inside the press molding machine, thereby making a test piece having a size of 80 mm×80 mm×5 mm (thickness);

(ii) taking out a test piece bonded to the aluminum foil;

(iii) peeling off the aluminum foil layer at its edge in 5 mm length with a cutter knife;

(iv) handpicking the peeled edge and further peeling off all the remaining parts of the aluminum foil; and

(v) ranking bonding capability (“good” or “bad”) of the test piece to aluminum (metal).

Table 4 shows the following:
Example 5 provided a test piece (heat dissipator) having small specific gravity, a high temperature-elevation speed, and good bonding capability to a metal;
Comparative Example 4 provided a test piece (non-foamed material) having larger specific gravity, and a lower temperature-elevation speed than that obtained in Example 5;
Comparative Examples 5, 6 and 7 using no modified polyolefin provided a test piece having bad bonding capability to a metal, and Comparative Examples 6 and 7 using no carbon fiber provided a test piece having a low temperature-elevation speed; and
comparing Comparative Examples 6 and 7 with each other (wherein (i) the both used no carbon fiber, (ii) Comparative Example 6 used no foaming agent, and (iii) Comparative Example 7 used a foaming agent), Comparative 7 provided a test piece (foamed material) having a lower temperature-elevation speed than a test piece (non-foamed material) obtained in Comparative Example 6, which is consistent with a heat insulating effect due to foaming generally known in the art, and is in contrast to a comparison of Example 5 with Comparative Example 4, wherein (i) the both used carbon fiber, (ii) Example 5 used a foaming agent, (iii) Comparative Example 4 used no foaming agent, and (iv) Example 5 provided a test piece (heat dissipator) having a higher temperature-elevation speed than a test piece (non-foamed material) obtained in Comparative Example 4.

1. A heat dissipator comprising foam of a resin composition, containing:
45.0 to 89.5% by weight of a thermoplastic resin;
10 to 50% by weight of carbon fiber; and
0.5 to 5.0% by weight of a modified polyolefin modified by an unsaturated carboxylic acid or its derivative;
wherein the resin composition has a melt flow rate of 5 g/10 minutes or more, measured at 230° C. under a load of 2.16 kg according to JIS K-7210, and the foam has a foaming ratio of 1.05 to less than 1.70, and has thermal conductivity in a horizontal direction of 1 W/mK or more, measured by a laser flash method, and thermal conductivity in a vertical direction of 0.6 W/mK or more, measured by a laser flash method, provided that the total weight of the thermoplastic resin, the carbon fiber, and the modified polyolefin is 100% by weight.

2. The heat dissipator according to claim 1, wherein the thermoplastic resin is a polyolefin resin.

3. The heat dissipator according to claim 1, wherein the foam has a foaming ratio of 1.05 to less than 1.50.

4. The heat dissipator according to claim 1, wherein the carbon fiber contained in the resin composition has number average fiber length of 0.5 mm or longer.

5. The heat dissipator according to claim 2, wherein the resin composition further contains 3 to 10 parts by weight of organic fiber, provided that the total weight of the polyolefin resin, the carbon fiber, and the modified polyolefin is 100 parts by weight.

6. A part for a lighting equipment, comprising the heat dissipator according to claim 1.
